(19) United States
(12) Patent Application Publication
(10) Pub. No.: US 2004/0250247 A1
(43) Pub. Date: Dec. 9, 2004

(54) Extensible software installation and configuration framework

(75) Inventors: David M. Deeths, San Diego, CA (US); Mark V. Garner, San Diego, CA (US); Enrique Vargas, San Diego, CA (US)

Correspondence Address: MEYERTONS, HOOD, KIVLIN, KOWERT & GOETZEL, P.C., P.O. BOX 398, AUSTIN, TX, 78767-0398, US

(73) Assignee: Sun Microsystems, Inc.

(21) Appl. No.: 10/457,669

(22) Filed: Jun. 9, 2003

(51) Int. Cl. G06F 9/445; G06F 9/44; G06F 13/00

(52) U.S. Cl. 717/175; 717/169; 717/115; 719/328

(57) ABSTRACT

A method for an extensible software installation and configuration framework may include providing a set of software modules operable to install and configure software on a computer subsystem. The set of software modules may also include one or more software module types, and each given software module type may be associated with one or more module type functions. The method may further include listing the set of software modules in a manifest file, reading the manifest file using an installation application, and installing each software module listed in the manifest file by calling the one or more module type functions.

### BACKGROUND OF THE INVENTION

1. Field of the Invention

This invention relates to the field of computer software and, more particularly, to the installation and configuration of computer software

2. Description of the Related Art

Modern computer systems must have software such as operating systems, applications, and drivers installed before the system can be productive. However, installing and configuring software manually is a difficult, time consuming, and error prone task that can take days or even weeks under the best conditions. Because a large number of tasks are involved in the setup process, it may be difficult to track where problems occur. In many cases, manual configurations may prove difficult to reproduce, because small differences in the procedure can have profound effects on the outcome.

Customers may be particularly interested in reproducing system configurations because standardization makes training easier, reduces the chances of operator error, and may provide an easy way to create identical test/staging configurations and disaster recovery solutions. While most computer manufacturers may provide pre-built systems in select configurations, the level of customization is not usually useful for server-class machines. For example, the change or upgrade of a single component from a pre-configured system may take hours or days of additional configuration work. Furthermore, the customer must often deal with post-installation problems without manufacturer support.

A number of solutions to the problem are possible. One such solution may be using change control procedures. By recording all changes to the system in precise detail, customers can follow a cookbook approach to installing and/or configuring systems. However, this assumes that no errors occur in recording configuration changes, or in implementing them from the cookbook. Implementing this process may also take a significant amount of time and manpower.

Alternatively, administrative shell scripts may be used to automate product installation and configuration as well as to automate other tasks. Such scripts may speed up the process as well as provide reproducible configurations. However, all but the most complex shell scripts may only be operable to produce single, monolithic configurations. Furthermore, these shell scripts may not adhere to a common application programming interface (API), the absence of which may entail additional maintenance and compatibility issues.

Current installation tools fail to address the fact that modern software may be installed in a plurality of different ways. Installation tools are often limited in what types of software installations and tasks they are able to perform, or they may require the user to manually script each installation or task to account for the variety. Manual scripting is a particularly complex problem, because software components and tasks can be instantiated in a number of different object classes, each potentially having class-specific methods of configuration, data access, and use.

### SUMMARY OF THE INVENTION

Various embodiments of a system and method for an extensible software installation and configuration framework are disclosed. In one embodiment, the method may include providing a set of software modules operable to install and configure software on a computer subsystem. The set of software modules may also include one or more software module types, and each given software module type may be associated with one or more module type functions. The method may further include listing the set of software modules in a manifest file, reading the manifest file using an installation application, and installing each software module listed in the manifest file by calling the one or more module type functions.

### BRIEF DESCRIPTION OF THE DRAWINGS

FIG. 1 is a block diagram of one embodiment of a computer subsystem.

FIG. 2 is a block diagram of one embodiment of a system for installing and configuring software on a computer subsystem.

FIG. 3 is a flow diagram describing the operation of one embodiment of a system for installing software on a computer subsystem.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

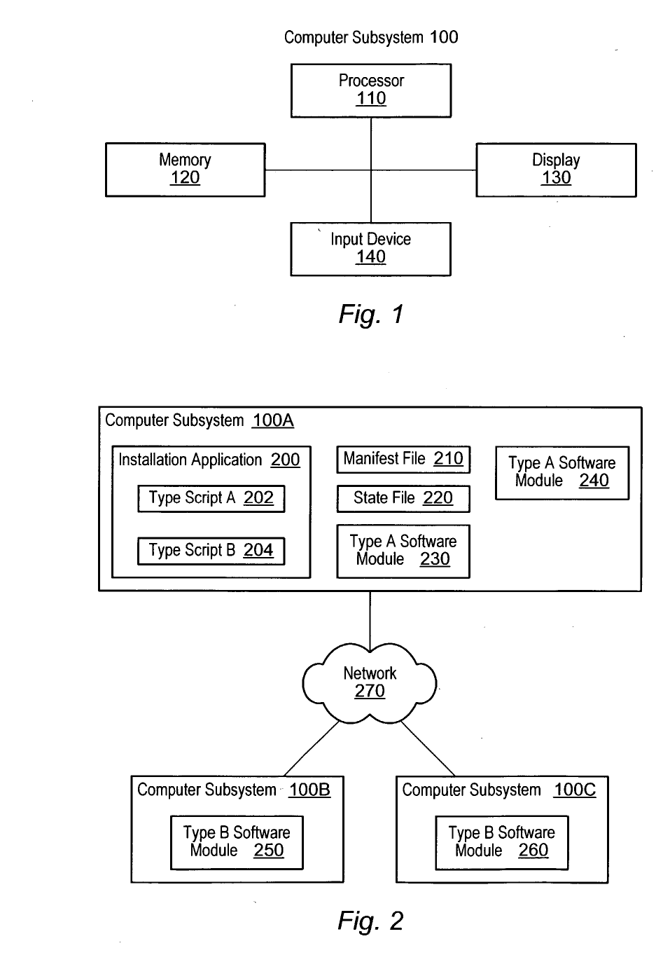

Turning now to FIG. 1, block diagram of one embodiment of a computer subsystem 100 is shown. Computer subsystem 100 includes a processor 110 coupled to a memory 120, a display 130, and an input device 140. It is noted that computer subsystem 100 may be representative of a laptop, desktop, server, workstation, terminal, personal digital assistant (PDA) or other type of system.

Processor 110 may be representative of any of various types of processors such as an x86 processor, a PowerPC processor or a CPU from the SPARC family of RISC processors.

Memory 120 may be representative of any of various types of memory, including DRAM, SRAM, EDO RAM, Rambus RAM, etc., or a non-volatile memory such as a magnetic media, e.g., a hard drive, or optical storage, for example. It is noted that in other embodiments, the memory 120 may include other types of suitable memory as well, or combinations of the memories mentioned above.

Display 130 may be representative of any of various types of displays, such as a liquid crystal display (LCD) or a cathode ray tube (CRT) display, for example. As shown in FIG. 1, computer subsystem 100 may also include an input device 140. The input device 140 may be any type of suitable input device, as appropriate for a particular system. For example, the input device 140 may be a keyboard, a mouse, a trackball or a touch screen.

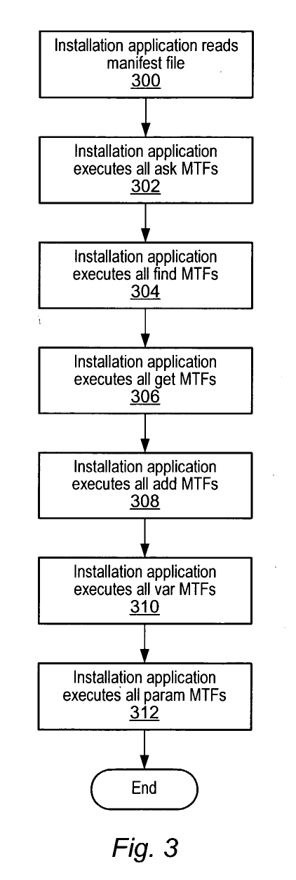

As will be described in greater detail below in conjunction with FIGS. 2-3, processor 110 of computer subsystem 100 may execute software configured to automatically install and configure software on a computer subsystem. The installation and configuration software may be stored in memory 120 of computer subsystem 100 in the form of instructions and/or data that implement the operations described below.

FIG. 2 illustrates one embodiment of a system for installing and configuring software on a computer subsystem. The system includes computer subsystems designated 100A-C connected by a network 270. It is noted that in other embodiments the system may include greater or fewer numbers computer subsystems.

It is noted that network 270 may be any type of network, such as local area network (LAN), a wide area network (WAN), or the Internet, for example.

In the illustrated embodiment, computer subsystem 100A includes installation application 200, manifest file 210, state file 220, and software modules 230, and 240. Computer subsystem 100B includes software module 250, and computer subsystem 100C includes software module 260.

Computer subsystem 100A is the computer subsystem on which software is to be installed and configured. Computer subsystem 100A may be configured to execute installation application 200. In one embodiment, installation application 200 may be a UNIX shell script, while in various alternative embodiments installation application 200 may be a Java program, a compiled executable, or a script in an interpreted scripting language such as Perl, for example. The installation application 200 may install software modules 230, 240, 250 and 260 by executing functions from a common interface, as will be described further below.

In the illustrated embodiment, installation application 200 includes type script A 202 and type script B 204, each of which may be configured to implement one or more functions, which are described below, for a specific type of software module. As used herein, these implemented functions are referred to as module type functions (MTFs). In one embodiment, type script A 202 may be a UNIX shell script, or a collection of shell scripts, for example. Alternatively, type script A 202 may be representative of a Java program, a compiled executable, or a script in an interpreted scripting language such as Perl.

Each of software modules 230, 240, 250 and 260 may embody various software module types, (e.g., type A and type B software modules). Both type A and type B may represent different types of software modules, such as tar files, zip files, SVR4 packages, RedHat packages, executables, or various types of software patches, for example. It is noted that other embodiments may include any number of software module types. Each different software module type may require a different type script in the installation application (e.g. type script A 202 and type script B 204) to implement the common MTFs described below. However, the functionality and implementation details for each MTF may be different.

In one embodiment, the MTFs implemented by each type script may include a ‘find’ MTF, a ‘get’ MTF, an ‘add’ MTF, an ‘ask’ MTF, a ‘var’ MTF and a ‘param’ MTF. The ‘find’ MTF may be executable to locate and list the location of a specific software module. The ‘get’ MTF may be executable to retrieve the software module from the location listed by the ‘find’ MTF. The ‘add’ MTF may be executable to install the software module retrieved by the ‘get’ MTF. The ‘ask’ MTF may be executable to query the end user for a piece of information needed for the installation and configuration process and encode that piece of information in a common format. The ‘var’ MTF may be executable to output a piece of information encoded by the ‘ask’ MTF. The ‘param’ MTF may be executable to output a piece of static, software module-specific information.

It is noted that in various alternative embodiments, additional MTFs having additional functionality may be included. It is further noted that other embodiments may not include each of the MTFs described above. In one embodiment, each MTF in all type scripts may include certain default functionality that may be overridden or extended by each individual type script. For example, in one embodiment, all ‘get’ MTFs may provide default functionality to allow for a software module to be downloaded by FTP. However, a particular ‘get’ MTF associated with a specific type script may provide additional functionality to allow for a software module to be downloaded by secure FTP, while another ‘get’ MTF associated with a different type script may allow for a software module to be downloaded by HTTP. Such additional functionality may be in the form of a hierarchy of subfunctions associated with each MTF.

Manifest file 210 may include a list of all software modules to be installed on computer subsystem 100A. In one embodiment, the modules may be specified in manifest file 210 by their location (e.g., the absolute path). Alternatively, the modules may be specified in manifest file 210 by their module name using a configuration file that may include a list of potential locations for each software module at various local and network addresses. By installing each software module in the order listed in the manifest file 210, a given set of software which is commonly referred to as a software stack will be installed and configured on computer subsystem 100A. Using the described system, software stacks with substantially identical configurations and functionality may also be installed on any other computer subsystem that executes installation application 200 with the same manifest file 210 and software modules 230, 240, 250, and 260. Accordingly, reproducible system configurations may be provided from system to system.

It is noted that in one embodiment, software modules 230, 240, 250 and 260 may additionally contain their own sub-manifest files (not shown) similar to manifest file 210. These sub-manifest files may be substantially identical to manifest file 210 in format and functionality, but may contain a further sub-list of software modules and tasks to be installed relating to the installation and configuration of a top-level software module 230, 240, 250 or 260.

Depending on the configuration of a given computer system, certain software modules may require a reboot of the computer system for the installation to be complete. In one embodiment, state file 220 may operate as an installation log and a persistent memory for installation application 200. For example, as installation application 200 progresses through manifest file 210, additional information may be added to state file 220 indicating which software modules have already been installed. In one embodiment installation application 200 may list a software module in state file 220 after software installation of the module has successfully occurred. Installation application 200 may then compare manifest file 210 to state file 220 after each reboot to determine which software modules have already been installed, and which remain to be installed. By comparing state file 220 with manifest file 210, a determination may be made as to how far along an installation is, thereby allowing an installation to be restarted after an error in a given module, for example.

In one embodiment, software modules may provide an exit code upon completion specifying such events as a successful completion or an error, for example. These codes may be used to control if and when a reboot of a computer system should occur.

In one embodiment, manifest file 210 may include override codes that may override actions associated with an MTF. For example, manifest file 210 may include an override code associated with a particular ‘add’ MTF that, when triggered, prevents the ‘add’ MTF from executing. Alternatively, an override code may specify that a ‘param’ MTF may change the information to be output.

FIG. 3 illustrates a flow diagram describing the operation of one embodiment of a system for installing software on computer subsystem 100A of FIG. 2. Referring collectively now to FIGS. 2-3, in step 300, installation application 200 reads the contents of manifest file 210 to obtain an overview of what software modules and associated MTFs may be accessed and/or executed. As described above, manifest file 210 includes a list of software modules 230, 240, 250, and 260.

In step 302, installation application 200 may call each ‘ask’ MTF associated with each software module found in step 300. As described above, the ‘ask’ MTF may be operational to query the end user for any additional information needed for the installation process, such as a network address or a file location, for example. This information may then be encoded in a common format for later reference, as previously described.

It is noted that, by executing all ‘ask’ MTFs at the beginning of the execution process, installation application may thus streamline the installation process by allowing the end user to answer configuration information queries at the beginning of the installation process. It is further noted that, in one embodiment, the end user may answer all such ‘ask’ MTF queries at one time and location, suspend the installation process, and continue the process at a later time and different location. This feature may allow for key installation and configuration location information to be entered prior to installing software modules 230, 240, 250 and 260 at a target installation location. In addition, all ‘find’ or ‘get’ MTFs may be executed in a similar manner as described further below. In this way all software modules that are to be installed may be found and retrieved before any are installed.

In step 304, installation application 200 may invoke each ‘find’ MTF associated with each software module listed in manifest file 210. As described above, the ‘find’ MTF may be operable to locate a target software module. In various embodiments the ‘find’ MTF may return the locations of software modules on a hard drive, a network file system, a removable media drive such as a CD or DVD drive, on a local network or on the Internet, for example. In one embodiment, the ‘find’ MTF may systematically search the list of potential software module locations described above in FIG. 2.

In step 306, installation application 200 may invoke each ‘get’ MTF associated with each software module listed in manifest file 210. In one embodiment, the ‘get’ MTF may copy or move software modules from one location in a file system to another. Alternatively, the ‘get’ MTF may further invoke transfer mechanisms such as file transfer protocol (FTP), hypertext transfer protocol (HTTP) or other mechanisms, as specified by type script A 202 and type script B 204, for example.

It is noted that, in another embodiment, installation application 200 may invoke the ‘find’ and ‘get’ MTFs associated with each software module together, rather than invoking all ‘find’ MTFs and then all ‘get’ MTFs. For example, installation application 200 may invoke the ‘find’ MTF found in type script B 204, immediately followed by the ‘get’ MTF from type script B 204, in order to retrieve software module 250 from computer subsystem 100B. It is further noted that, as described above, a software module may contain an additional sub-manifest containing additional software modules not listed in manifest file 210. In one embodiment, the ‘find’ and ‘get’ MTFs may operate recursively to locate and retrieve all software modules in a sub-manifest before finding and retrieving the next software module listed in manifest file 210.

In step 308, once all the software modules that are to be installed have been retrieved, installation application 200 may invoke the ‘add’ MTF associated with each software module to install and configure each software module. In one embodiment, the ‘add’ MTF may unpack the various archives embodied by the software module with archive-specific commands. In addition, the ‘add’ MTF may move or copy unpacked files or classes to other locations on computer subsystem 100A. Further, the ‘add’ MTF may perform configuration tasks such as the modification of configuration files or environment variables, such as a PATH variable, for example. In addition, the ‘add’ MTF may execute or cause to be executed the selected software module, or a portion thereof.

In step 310, installation application 200 may invoke the ‘var’ MTF associated with each software module. As described above, the ‘var’ MTF may be operable to retrieve installation and configuration information acquired in step 302 by the ‘ask’ MTF, as described above. Installation application 200 may invoke the ‘param’ MTF associated with the selected software module type in step 312. The ‘param’ MTF may be operable to retrieve static information specific to the selected software module, as described above. It is noted that, in one embodiment, both the ‘var’ and ‘param’ methods from steps 310 and 312, respectively, may be called in association with another MTF, such as the ‘add’ MTF, for example, thereby providing necessary installation and configuration information.

Each software module 230, 240, 250 and 260 may have a specific set of MTFs invoked from an associated type script. To illustrate by example, software modules 230 and 240 are located on computer subsystem 100A, while software module 250 is located on computer subsystem 100B and software module 260 is located on computer subsystem 100C. Invoking the ‘get’ MTF of type script A 202, which is associated with type A software modules 230 and 240, may potentially cause no actions to occur, since software modules 230 and 240 are already located on local computer subsystem 100A. However, invoking the ‘get’ MTF of type script B 204, which is associated with type B software modules 250 and 260, may cause the installation application to retrieve software module 260 from computer subsystem 100B via network 270, possibly through the use of FTP, for example.

Likewise, in one embodiment a type A software module may be a zip file, requiring the use of a utility such as gzip, for example, to unpack and install. Thus, the ‘add’ MTF associated with software modules 230 and 240 would be operable to provide functionality to interact with the gzip utility. Alternatively, a type B software module may be a tar file, for example, requiring interaction with the tar utility to unpack and install. Thus, the ‘add’ MTF associated with software modules 250 and 260 may provide the required functionality required to interact with the tar utility.

In other embodiments, certain MTFs may be operable only to change the configuration of previously installed software on a computer subsystem. In such embodiments, all MTFs, with the exception of the ‘add’ MTF, may be “stub” or “dummy” MTFs which may be called but perform no actions. For example, only the ‘add’ MTF may be operable to execute any instructions on the computer subsystem, such as modifying a configuration file. In such an example, MTFs such as ‘find’ and ‘get’ may execute no instructions when called. Likewise, other embodiments may include software modules that may contain patches for existing or newly installed software, rather than software modules for complete installation of a software package.

In the above examples, the implementation and formatting details would be entirely located within type script A 202 and type script B 204. Installation application 200 would invoke the same common MTFs on each module, thereby simplifying the installation procedure by providing a common installation and configuration interface, and further minimizing the amount of automation scripting involved with the installation process.

Further, as described above in conjunction with the descriptions of FIGS. 2 and 3, installation application 200 may provide an extensible framework for software installation and configuration. Any additional software module type may thus be installed on computer subsystem 100A by installation application 200, as long as installation application 200 includes a type script corresponding to the additional module type which conforms to the common MTF interface described above.

It is further noted that, in various alternative embodiments, installation application 200 may be configured to create a complete log of the actions taken by each software module (e.g., move commands, configuration variable modifications, etc.).

It is also noted that although manifest file 210 has been described in the above embodiments as a file, it is contemplated that in other embodiments the information included in manifest file 210 may be stored in other locations, such as an information service or a database, for example. Further, in one embodiment, the information in state file 220 may likewise be stored in an information service or database, for example.

It is noted that any of the embodiments described above may further include receiving, sending or storing instructions and/or data that implement the operations described above in conjunction with FIGS. 1-3 upon a computer readable medium. Generally speaking, a computer readable medium may include storage media or memory media such as magnetic or optical media, e.g. disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals conveyed via a communication medium such as network and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
providing a set of software modules, wherein each software module is operable to install and configure software on a computer subsystem, wherein said set of software modules includes one or more software module types, and wherein a given software module type is associated with one or more module type functions;
listing said set of software modules in a manifest file;
reading said manifest file using an installation application; and
installing each software module listed in said manifest file by calling said one or more module type functions.

2. The method of claim 1 wherein said one or more module type functions provides a default functionality to each of said software module types.

3. The method of claim 1 further comprising rebooting said computer subsystem during said installation of said set of software modules dependent upon an exit code provided by a given one of said set of software modules.

4. The method of claim 1 further comprising controlling said module type functions dependent on an override code in the manifest file.

5. The method of claim 3 further comprising listing each software module in a state file upon completion of said installation of each software module.

6. The method of claim 5 further comprising providing an indication that rebooting has already occurred using said state file.

7. The method of claim 1 wherein said one or more module type functions include a ‘find’ function operable to locate a software module.

8. The method of claim 1 wherein said one or more module type functions include a ‘get’ function operable to transfer a software module to said computer subsystem.

9. The method of claim 1 wherein said one or more module type functions include an ‘add’ function operable to install and configure a software module on said computer subsystem.

10. The method of claim 1 wherein said one or more module type functions include an ‘ask’ function operable to query an end user for a piece of information and encode said piece of information in a common format.

11. The method of claim 10 wherein said one or more module type functions include a ‘var’ function operable to retrieve said piece of information encoded by said ask function.

12. The method of claim 1 further comprising creating a log of each action taken by each software module.

13. A system comprising:
a computer subsystem;
a set of software modules including one or more software module types, wherein said set of software modules are operable to install software on said computer subsystem, and wherein each given software module type is associated with one or more module type functions;
a manifest file which includes a listing of said set of software modules; and
an installation application operable to read said manifest file, wherein said installation application is operable to install each software module by calling said one or more module type functions.

14. The system of claim 13 wherein said one or more module type functions provides a default functionality to each of said software module types.

15. The system of claim 13 wherein said installation application is operable to reboot said computer subsystem during said installation of said set of software modules dependent upon an exit code provided by a given one of said set of software modules.

16. The system of claim 13 wherein said installation application is operable to control said module type functions depending on an override code in the manifest file.

17. The system of claim 15 further comprising a state file operable to list each software module after said installation of each software module.

18. The system of claim 17 further comprising providing an indication that rebooting has already occurred using said state file.

19. The system of claim 13 wherein said one or more module type functions include a ‘find’ function operable to locate a software module.

20. The system of claim 13 wherein said one or more module type functions include a ‘get’ function operable to transfer a software module to said computer subsystem.

21. The system of claim 13 wherein said one or more module type functions include an ‘add’ function operable to install and configure a software module on said computer subsystem.

22. The system of claim 13 wherein said one or more module type functions include an ‘ask’ function operable to query an end user for a piece of information and encode said piece of information in a common format.

23. The system of claim 22 wherein said one or more module type functions include a ‘var’ function operable to retrieve said piece of information encoded by said ask function.

24. The system of claim 13 wherein the installation application is operable to create a log of each action taken by each software module.

25. A computer readable medium including program instructions executable to implement a method comprising:
providing a set of software modules, wherein each software module is operable to install and configure software on a computer subsystem, wherein said set of software modules includes one or more software module types, and wherein a given software module type is associated with one or more module type functions;
listing said set of software modules in a manifest file;
reading said manifest file using an installation application; and
installing each software module listed in said manifest file by calling said one or more module type functions.

26. The computer readable medium of claim 25 wherein said one or more module type functions provides a default functionality to each of said software module types.

27. The computer readable medium of claim 25 wherein the method further comprises rebooting said computer subsystem during said installation of said set of software modules dependent upon an exit code provided by a given one of said set of software modules.

28. The computer readable medium of claim 25 wherein the method further comprises controlling said module type functions dependent on an override code in the manifest file.

29. The computer readable medium of claim 27 wherein the method further comprises listing each software module in a state file upon completion of said installation of each software module.

30. The computer readable medium of claim 29 wherein the method further comprises providing an indication that rebooting has already occurred using said state file.
